(19) United States
(12) Patent Application Publication
(10) Pub. No.: US 2026/0253297 A1
(43) Pub. Date: Aug. 27, 2026

(54) REPLAY OF EXPERIENTIAL RECORDINGS

(71) Applicant: VRChat Inc., San Francisco, CA (US)

(72) Inventors: Eric Liu, Redwood City, CA (US); Mark Horn, Groningen (NL); Casey Wilms, Los Altos, CA (US); Jesse Joudrey, Maple Ridge (CA); Eric Kabisch, Los Angeles, CA (US)

(73) Assignee: VRChat Inc., San Francisco, CA (US)

(21) Appl. No.: 19/062,491

(22) Filed: Feb. 25, 2025

(51) Int. Cl. G06T 13/40; G06T 1/00; G06T 19/00

(52) U.S. Cl. CPC G06T 13/40; G06T 1/0007; G06T 19/003; G06T 2219/024

(57) ABSTRACT

The present technology pertains to experiential recordings in virtual environments, which enable users to capture and share immersive interactions. Unlike traditional streaming that offers only a visual perspective, experiential recordings document the state events and the user's movements and audio within the virtual world. This allows the original virtual experience to be reconstructed and shared, offering a view into the environment as initially experienced by the creator. The experiential recording involves capturing world state events that reflect the state of a world instance as experienced by a participatory user. The events are recorded over time with timestamps indicating when they were captured. This data is then sent to a client associated with a non-participatory user, allowing the non-participatory user to replay and experience the world instance as it was originally experienced by the participatory user.

### BACKGROUND

In recent years, virtual environments have evolved into complex and aesthetically rich domains, significantly enhancing the user's interactive experience. These environments are characterized by intricate designs and artistic elements that not only engage users but also provide a platform for creative expression. As these virtual landscapes become more sophisticated, they offer experiences that are immersive, enjoyable, and memorable.

The advent of virtual reality (VR) technology has further transformed these environments by allowing users to immerse themselves fully in a first-person perspective. This immersion creates a unique and personal experience, where users perceive and interact with the environment as if they were physically present. Such experiences are often intense and memorable.

### BRIEF DESCRIPTION OF THE SEVERAL VIEWS OF THE DRAWINGS

Details of one or more aspects of the subject matter described in this disclosure are set forth in the accompanying drawings and the description below. However, the accompanying drawings illustrate only some typical aspects of this disclosure and are therefore not to be considered limiting of its scope. Other features, aspects, and advantages will become apparent from the description, the drawings and the claims.

FIG. 1 illustrates an example virtual world platform for playing and hosting a multiplayer virtual reality (VR) experience in accordance with some embodiments of the present technology.

FIG. 2 illustrates the capturing of an experiential recording by a client that is associated with the participatory user in accordance with some embodiments of the present technology.

FIG. 3 illustrates the playback of an experiential recording or quasi-experiential recording by a client that is associated with the non-participatory user in accordance with some embodiments of the present technology.

FIG. 4 illustrates an example method for capturing an experiential recording and playing back the experiential recording in accordance with some embodiments of the present technology.

FIG. 5 illustrates an example method for capturing world state events to be part of an experiential recording and providing access to the experiential recording in accordance with some embodiments of the present technology.

FIG. 6 illustrates an example method for livestreaming an experiential recording in accordance with some embodiments of the present technology.

FIG. 7 illustrates an example method for elevating a non-participatory user to a quasi-participatory user in accordance with some embodiments of the present technology.

FIG. 8 illustrates an example method for explicitly creating a quasi-experiential recording in accordance with some embodiments of the present technology.

FIG. 9 shows an example of a system for implementing some embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

As the quality of experience in virtual environments has advanced, so too has the interest in recording aspects of these interactions for later viewing or sharing. For example, a pre-cursor to the present technology might be a user live streaming their gameplay or live streaming their interactions in a virtual world. But, such streaming is merely a video of a view into the virtual world. Just as the interactions available in virtual worlds are immersive and interactive, so should the recordings of experiences.

However, sharing first-person perspectives from virtual reality presents challenges, as these experiences are inherently subjective and tailored to individual interaction within the virtual space. As a result, there is a growing need for methods and tools that enable users to effectively capture and convey their unique experiences in virtual environments, thereby allowing others to partake in the richness and enjoyment of these artistic and interactive digital worlds.

The present technology pertains to experiential recordings in virtual worlds. An experiential recording is a recording of state events needed to reconstruct the state of a virtual world and the movements and audio that combine to create an experience. The experiential recording can be shared (or viewed later by the user creating the experiential recording) so that a user can see the virtual world as the user who originally participated in the world at that time.

In some embodiments, the user consuming the experiential recording can also have deeper experiences and view other aspects of the world as it existed during the experiential recording.

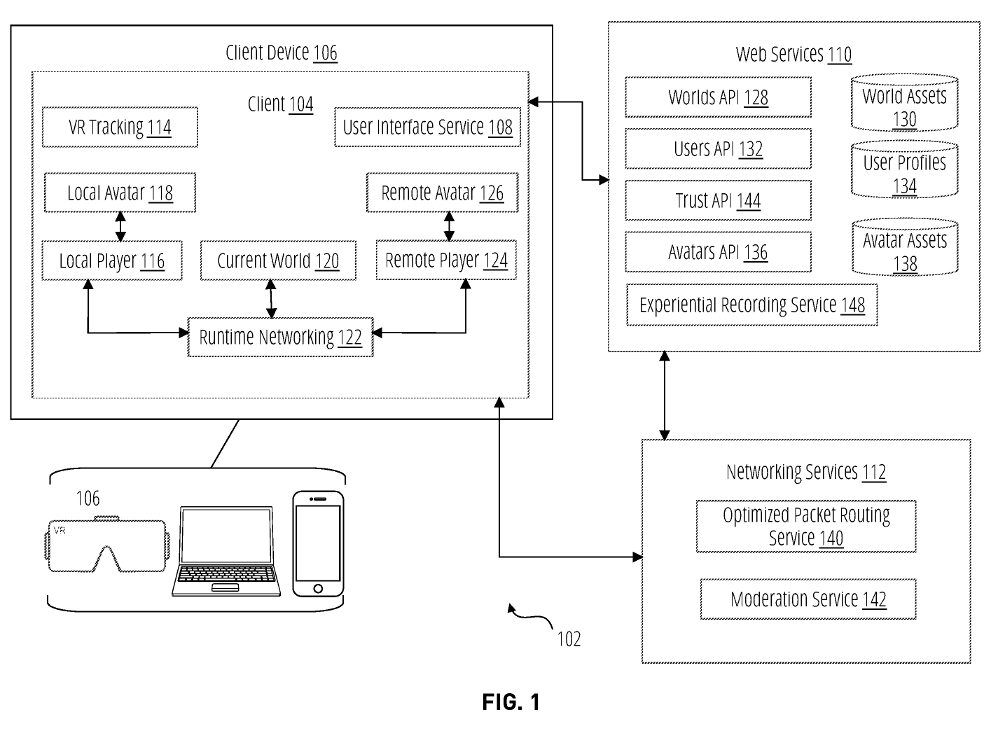

FIG. 1 illustrates an example virtual world platform 102 for playing and hosting a multiplayer virtual reality (VR) experience that is suited to carrying out the present technology. The virtual world platform 102 can connect clients 104 through web services 110 and networking services 112 to socially interact together in a virtual world hosted by virtual world platform 102.

The virtual world platform 102 primarily includes a client 104, which is an instance of an application executed on a client device 106. The client 104 interacts over a network connection with web services 110 which supports client 104 by providing various services through one or more application programming interfaces (APIs). A few of the main services provided by web services 110 are related to supporting virtual worlds through the worlds API 128, user profiles through the users API 132, trust and safety through the trust API 144, and complex avatars through avatars API 136. Web services 110 generally stores and provides long-term state information among other functions.

The client 104 also interacts with networking services 112, which provides communication services between client 104, networking services 112, and a remote instance of client 104 (not shown) to share state information among respective instances of client 104. In particular, state information is received from a plurality of instances of client 104 by networking services 112 as each instance of client 104 controls its local player 116. Networking services 112 can transfer state information about respective players to other instances of client 104 when the local players 116 for the respective client instances are all engaged in gameplay in the same virtual world. The networking services 112 provide optimized packet routing through optimized packet routing service 140 and moderation between one or more clients through moderation service 142.

The client 104 is the runtime environment executing on a particular client device 106. While the present description sometimes refers to client 104, local client, remote clients, client that is associated with the participatory user, and client that is associated with the non-participatory user, all are instances of the client 104 executing on a respective client device 106. One particular user account is logged into a particular instance of client 104. A local client and remote client are distinguished to illustrate how client 104 handles first person inputs from a user of the client device 106 upon which client 104 is executing and handles third party inputs received from another user operating their client device upon which the remote client is executing.

Client device 106 can be any computing device. While client 104 is particularly adapted to providing an immersive virtual reality experience through interactions that require a VR headset to experience, client 104 can also be run by computers and mobile devices. Some virtual worlds or complex avatars might not be configured to perform well on certain device types, and therefore, while client 104 can operate on many platforms and devices, not all virtual worlds or complex avatars will be available or have full functionality on all client devices 106.

User interface service 108 is a service that is part of client 104. User interface service 108 is configured to provide various user interface elements such as menus that display various user settings, available worlds, saved complex avatars, friends lists, etc. User interface service 108 can populate its menus through interaction with one or more APIs provided by web services 110, while other portions of menus are loaded directly from user interface service 108.

User interface service 108 can provide a menu of available worlds by calling worlds API 128 to retrieve a list of worlds to which the user account logged into client 104 is permitted to enter. Worlds API 128 can retrieve all public worlds from the world assets database 130 and send a list of those to client 104. Additionally, worlds API 128 can request world IDs for any private worlds associated with the user account logged into client 104 and retrieve the private worlds from the world assets database 130 to send to client 104. User interface service 108 can receive user inputs through a hardware interface to navigate through the worlds menu and to receive a selection of a world to visit.

Another user interface provided by user interface service 108 pertains to various user settings. Such settings can pertain to whether the human player is sitting or standing, settings to minimize motion sickness in players that are susceptible to motion sickness when playing in VR, settings to select a complex avatar, settings about how a player might be viewed and by whom a player might be viewed in a virtual world.

One notable user interface provided by the user interface service 108 is the trust and safety menu. User interface service 108 can contact users API 132 to retrieve current trust and safety settings from user profiles database 134 and display these settings in the trust and safety menu. The trust and safety menu provides the user account with the ability to determine which remote players 124 can see the user's avatar (local player 116) or be seen by the user’s avatar when they are both in the same world. For example, it may be desirable to avoid interacting with newer users of the virtual world platform 102 since they have not built up trust within the virtual world platform 102. It may also be desirable to limit the features of a remote player's avatar that will be processed by the instance of client 104 to which the local user is logged in. This is because some avatars may have malicious data embedded, or the avatars may be too complex to render without degrading the performance of client device 106. For example, a user account might decide to turn off lights on remote avatars to avoid shaders, disallow custom animations, etc. In some embodiments, each of these options might be set based on how trusted the remote player is. For example, a user account might allow their friend’s avatars to have full features, while others only display basic avatar features.

The user interface service 108 can also provide options to mute or block specific remote players. Additionally, the user interface service 108 can provide a panic mode to audio-and-visually mute anybody who is not a friend.

After a user has selected a virtual world from the menu provided by the user interface service 108, client 104 can download an instance of the virtual world by calling the worlds API 128, which can retrieve the virtual world from worlds world assets database 130 and send it to client 104 for execution.

The world assets are large binary files built for a game engine, such as UNITY using an editor with a software development kit (SDK) provided for use with the virtual world platform 102. If a user travels into a world, they need to download that world asset from world assets database 130. If there are already people in that instance of the world, client 104 also needs a list of the avatars of those people so that the avatars can be rendered in the instance of the virtual world.

In some embodiments, a function of the worlds API 128 can confirm that the user account can access the requested world. While the user account should only have the ability to view public worlds in the user interface menu or should only have knowledge of links to worlds that have been shared with the user account, the worlds API 128 can confirm the user account is permitted to access the virtual world as a redundancy measure.

In addition to downloading the instance of the virtual world, the client 104 can also establish a session with networking services 112 for the specific instance of the world. Networking services 112 can provide information about the current state of the instance of the virtual world. For example, networking services 112 can provide a list of remote avatars 126 present in the virtual world instance to client 104. In turn, client 104 can contact the avatars API 136 to download complex avatar assets for the list of remote complex avatars from avatar assets database 138.

If the client 104 does not have assets for the local avatar 118, client 104 can also contact the avatars API 136 to request and receive the local avatar assets. Avatar assets are a single binary file that contains all of the textures and models and animation data needed to render the avatar. In some instances, more complicated features can be included such as data about particle systems or light sources, or if the avatar should obey or defy laws of physics established in a virtual world, or if the avatar has non-standard movement dynamics.

The downloaded instance of the virtual world can be executed by client 104 as current world 120. Current world 120 can include coordinates within the current world 120 where the local player 116 and each remote player 124 are located. The local player 116 and remote player 124 are each collision volumes of space that the respective local player 116 or remote player 124 occupy.

The local avatar 118 can be mapped to the local player 116, and the respective remote avatar 126 can be mapped to their respective remote player 124, thereby allowing each player to appear as their avatar in the current world 120. Movements of the remote avatars 126 are handled by receiving state data about a respective remote avatar/player and rendering the movement or audio by client 104.

The VR tracking service 114 pertains to clients 104 operating on a client device 106 that have access to VR tracking peripherals. For example, some VR headsets have cameras (integrated or external) to track the limbs of players. Many VR headsets can pair with controllers that can report the locations of a user's hands in space. Some client devices 106 include other peripherals configured to perform full skeleton tracking. VR tracking service 114 can fuse all VR inputs connected to the client.

The VR tracking service 114 can map the fused VR inputs to the local player 116 to allow the local player 116 to interact in and with the current world 120. Meanwhile, the local player 116 can interact with the local avatar 118 to map the local avatar 118 to the local player and make the local player 116 appear as their avatar.

In some embodiments, there is diversity in what parts of a user’s body are tracked by VR tracking service 114. While some users might have full skeleton tracking, many users may only have the ability to perform hand tracking. To accommodate this disparity in hardware abilities of possible client devices 106, local player 116 can derive portions of a skeleton that are not tracked by VR tracking service 114. For example, if VR tracking service 114 only provides information about hand tracking for a user, the local player can still derive a full skeleton for the user and make portions of the skeleton move to accommodate the movement of the hands. In this way, an avatar's hands are not moving in a way that is disembodied from the rest of the avatar.

The local player 116 is the entity that moves around the environment in the current world 120. It can pick things up and put them down. It does not have any animation and is a collision volume. It can do everything in the world, but it has no appearance and does not need to animate.

The local player is further connected to the networking layer, illustrated as the runtime networking service 122, to broadcast state information about the local player 116 over the network to other users in the current world 120 instance.

The local player 116 and the remote player 124 are similar in that they are collision volumes that move around the environment in the current world 120. The main difference is that the local player 116 is controlled by client 104, and the user of client 104 is authoring the experience. In contrast, the remote player 124 is a playback mechanism representing actions being broadcast to the client 104 representing other players present in the current world 120.

As addressed above, the local avatar 118 is overlaid with the local player 116 to give the user a visual appearance. Actions by the local player 116 are animated as the local player interacts with the current world. For example, while the local player 116 can interact to pick up an object in the current world 120, without the local avatar 118, the object would appear to float in the air. With the local avatar 118 overlaid the local player 116, the object now appears to be held by the hand of the avatar.

The remote player 124 and remote avatar 126 work similarly to their local counterparts except for where the inputs that control the remote player 124 come from. The remote player 124 and remote avatar 126 are playback devices for state information received by the runtime networking service 122 from networking services 112. While FIG. 1 only depicts one remote player 124 and remote avatar 126, there can be many.

The current world 120 also has features that require networking. The current world 120 could have objects, like scissors or a light switch, that a user can pick up, and the object needs to broadcast its state across the network so that other users in the current world 120 can view the current state of the object.

Each of the local player 116, current world 120, and remote player 124 are connected to the runtime networking service 122. The local player 116 primarily transmits updated state information for the local player 116 to remote instances of client 104 that are also executing the same virtual world. The current world 120 can transmit and receive state information about the instance of the virtual world. The current world executing on client 104 transmits state information when the state change is owned by the local player 116 and receives state information when the state change is owned by the remote player 124.

Networking services 112 are the network-side part of the networking layer of the virtual world platform 102. In some embodiments, portions of the networking services 112 are provided by a networking plug-in such as the PHOTON networking engine, which broadcasts state information to all users in an instance of a virtual world.

In addition to the general broadcasting of state information to all users interacting with an instance of a virtual world, the optimized packet routing service 140 provides more advanced features that provide an enhanced user experience and enforces other virtual world platform 102 properties, such as trust and safety configurations.

For example, to provide an enhanced user experience, the optimized packet routing service 140 can filter out voice packets coming from a remote player 124 that might be far from the local player 116 in the instance of the current world 120. Without such optimization, remote players 124 that are not interacting or even visible to the local player might receive audio packets from tens or even hundreds of remote players 124 that would make it hard to communicate with any subsets of remote players 124.

In another example, the optimized packet routing service 140 can enforce trust and safety configurations. As addressed above, trust and safety configurations can specify specific user accounts or groups of user accounts to be filtered so that they cannot interact with the local player 116 or have limited interactions with the local player 116. The optimized packet routing service 140 can call trust API 144 to learn of a list of remote players 124 that might need to be subject to some level of filtering or blocking of network traffic going to or coming from the client 104 for the local player 116 having the trust and safety configurations.

The trust API 144 can determine which remote players 124 should be blocked for the local player 116 or which remote players 124 should have aspects of their complex avatar limited. Some of these determinations are based on logic and rules that categorize remote players 124 based on quantities and types of past interactions with the virtual worlds platform 102. Trust API 144 may make these determinations by using settings stored in the user profile of the local player 116 and comparing these settings to data stored in user profiles of remote players 124.

Another of the networking services 112 is a moderation service 142 that can provide conflict resolutions and access control. For example, before a user accesses a world, especially a private world, moderation service 142 can call the worlds API 128 to ensure the user can enter the world. In another example, there can be instances where two different users attempt to claim control of an object in a virtual world at approximately the same time. The moderation service 142 can handle those sorts of conflicts by selecting a particular user to control an object until they relinquish the control of the object, which allows another user to claim control of the object. A user that has control of the object can broadcast packets informing remote players 124 of the state of that object.

In some embodiments, client 104, virtual worlds, and complex avatars can be configured to operate in a particular game engine, especially a game engine that supports three-dimensional (3D) environments. Two common game engines include UNITY and UNREAL ENGINE.

In some embodiments, to be supported by virtual world platform 102, virtual worlds and complex avatars need to be developed in compliance with a software development kit (SDK). For example, complex avatars require a particular script to be usable in the virtual world platform 102. In another example, there can be a number of requirements that need to be followed to get the animations of an avatar to play. In some embodiments, the SDK can define other necessary details to support particular client devices. For example, the SDK can define specific shaders to be used if the avatar is to be used on the OCULUS QUEST VR headset.

In some embodiments, the SDK requires virtual worlds to utilize a particular coding language to ensure the world has compliant behaviors. For example, the SDK can require that behaviors in worlds are defined using UDON, a programming language specific to a particular virtual world platform 102, VRCHAT. In some embodiments, the programming language facilitates a world built using the programming language to comply with file access safeguards provided by the virtual world platform 102. For example, a world cannot read or write anything to a hard drive, and only approved web pages can be rendered in a world on the virtual world platform 102.

As addressed above, one embodiment of the present technology pertains to capturing and sharing experiences through an experiential recording. Experiential recording service 148 is a service that can be used to support an experiential recording feature and that can facilitate sharing of the experiential recording. For example experiential recording service 148 can create links to the experiential recording, whether the experiential recording is streamed in nearly real time, or previously recorded. When the experiential recording is accessed via the link, the experiential recording service 148 can be used to send or stream the experiential recording to the link caller (or cause the experiential recording to be sent or streamed to the link caller).

While the virtual world platform 102 is suited to carrying out the present technology, persons of ordinary skill in the art will appreciate that the present technology can be used in other environments.

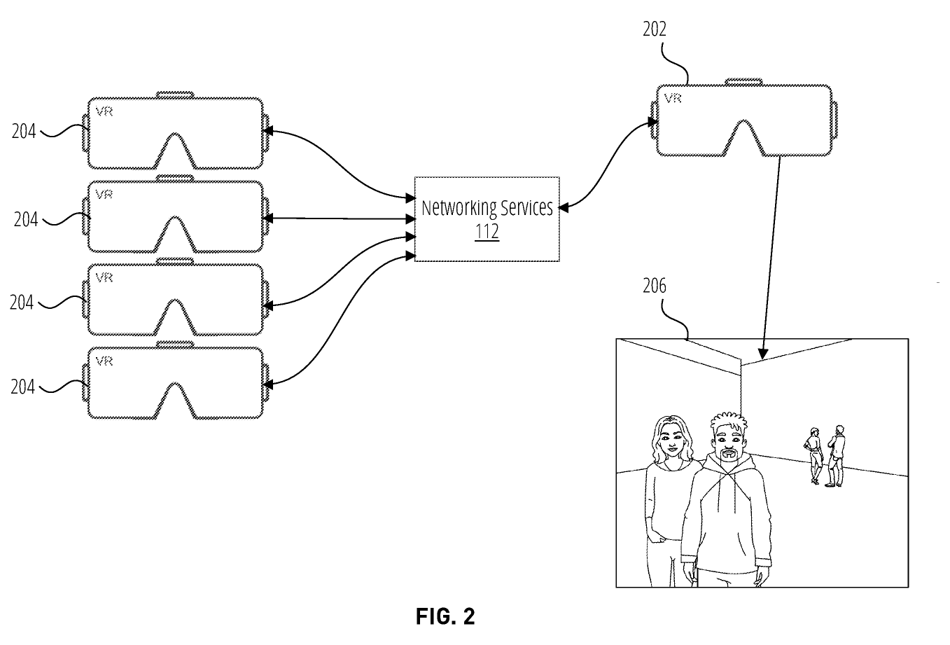

FIG. 2 illustrates the capturing of an experiential recording by a client that is associated with the participatory user in accordance with some embodiments of the present technology.

FIG. 2 illustrates a plurality of VR headset client devices. For example, the client that is associated with the participatory user 202 and the remote player client 204 are both depicted as VR headset devices. While FIG. 2 depicts VR headset client devices, the more important aspect is the client application (e.g. client 104) that is running on these devices. The particular device or form factor of the device (client device 106) is less important. There is no requirement that the device be an immersive or spatial computing device. The device can be a personal computer, laptop, mobile device, etc.

The devices in FIG. 2 are all participatory users that are engaged in a virtual world by way of experiencing the virtual world through interactions of the avatars, which the respective participatory users' control. While users associated with the remote player clients 204 are participatory users, the client that is associated with the participatory user 202 is distinguished because this user is the focus of the example.

The user associated with the client that is associated with the participatory user 202 is engaged in a participatory experience in a virtual world that is also occupied by other participatory users associated with the remote player clients 204. The client that is associated with the participatory user 202 provides a view of the virtual world to the user with which it is associated.

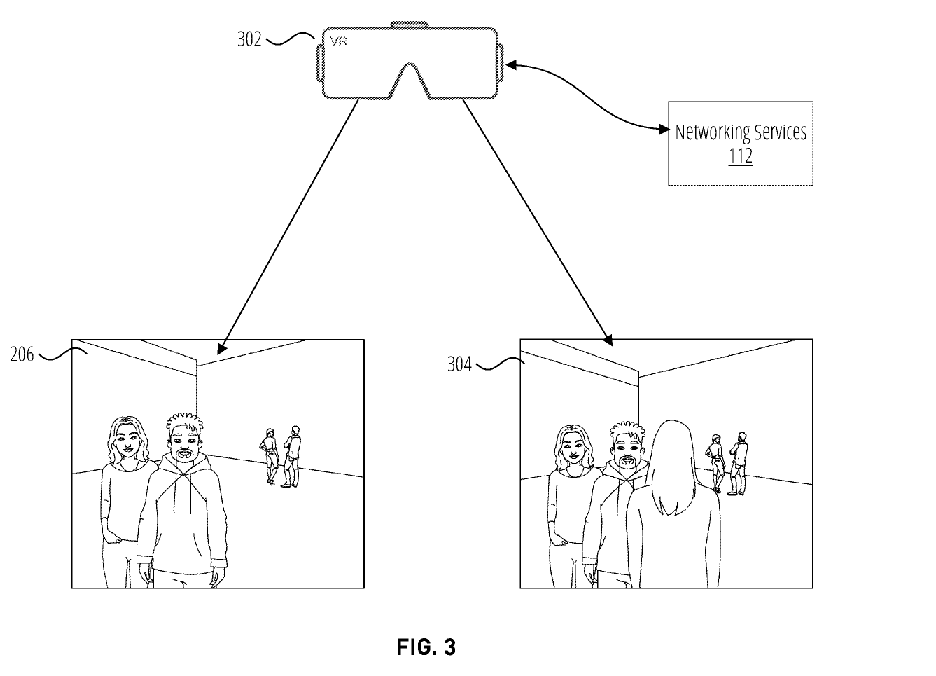

In this example, the client that is associated with the participatory user 202 can record an experiential recording, which is illustrated as view of experiential recording 206. In 206, the user is interacting with two avatars in the foreground, and two other avatars can be seen in the background. The user associated with client that is associated with the participatory user 202 is not shown since the view of experiential recording 206 is seen through the first person perspective of the user's avatar. (This can be contrasted with 304 in FIG. 3, which shows all five avatars in the recorded environment.)

The experiential recording is a collection of world state events that can be used to recreate the world as captured by the client that is associated with the participatory user 202. The world state events can include an identification of a world that is rendered by the client that is associated with the participatory user 202, avatars in the world, their locations over time, audio sources from the world, etc. Importantly, the experiential recording is not a video recording, which would result in too large of a file size, and limits the potential experience of the non-participatory user that views the experiential recording. Thus, while it is referred to as a recording, the experiential recording is really a collection of state data that can be used to recreate the world as captured by the client that is associated with the participatory user 202.

Any client 104 should be able to receive the collection of state data making up the experiential recording and load a copy of the world identified in the experiential recording, load the avatars into the world at the designated locations, and provide a view into the world . As time progresses, the client 104 can process additional state data that define the kinematics of the avatars so that the avatars move as they did when the recording was captured. The audio from the avatars can also be played back using the same algorithms and rules used to govern that audio when it was played in when the recording was captured (avatars that are further away might have their voices played back at a lower volume or not at all).

To the client 104 that might be playing back the experiential recording, the rendering the virtual world and remote avatars are the same as it would be if the user were actively controlling the avatar. In some embodiments, the client can provide a passive viewing experience to the non-participatory user as the client 104 consumes events that control the point of view and speech emanating from the avatar and plays them back from the data making up the experiential recording. In some embodiments, the client can receive inputs to navigate a quasi-participatory user about the virtual world so the quasi-participatory user can view the world from other points of view.

Capturing world state events rather than video recordings is more efficient. For example, a 30 second recording of all world state events going on in a virtual world might be about 1MB, whereas video covering even a small virtual world for 30 seconds could be 10MB or larger depending on number of camera angles, resolution, and frames per second.

Not only is the mechanism more efficient from a file size perspective, this mechanism supports both fully passive consumption of the experiential recording where the user is fully a non-participatory user but also supports the ability of the user to become a quasi-participatory user. A quasi-participatory user is a user that is generating unique first person events into the world represented in the experiential recording as will be explained in more detail herein.

A non-participatory user and a quasi-participatory user are similar, with the only difference being that the quasi-participatory user can provide inputs into the copy of the virtual world to navigate their point of view into the world (and maybe provide other inputs, like speech), whereas a non-participatory user is a passive user that views the copy of the world through the point of view of a participatory user captured in the experiential recording. A non-participatory user can become a quasi-participatory user, and a quasi-participatory user can become a non-participatory user. As used herein, the term non-participatory user should be understood to encompass both the non-participatory user and the quasi-participatory user, unless it is explicitly stated that the non-participatory user is acting in a passive mode.

FIG. 3 illustrates the playback of an experiential recording or quasi-experiential recording by a client that is associated with the non-participatory user in accordance with some embodiments of the present technology.

FIG. 3 illustrates VR headset client device. For example, the client that is associated with the non-participatory user (or quasi-participatory user) 302 is depicted as a VR headset device. While FIG. 3 depicts a VR headset client device, the more important aspect is the client application (e.g. client 104) that is running on this device. The particular device or form factor of the device (client device 106) is less important. There is no requirement that the device be an immersive or spatial computing device. The device can be a personal computer, laptop, mobile device, etc.

In FIG. 3, the client that is associated with the non-participatory user (or quasi-participatory user) 302 is consuming the experiential recording captured in FIG. 2. The client 302 is displaying the view of experiential recording 206 that is the same as the client that is associated with the participatory user 202 displayed when the experiential recording was captured.

The client 302 has either downloaded the experiential recording or the events making up the experiential recording are being streamed to the client 302 from the networking services 112.

As long as the non-participatory user operating client 302 passively consumes the experiential recording, the non-participatory user would experience the entire recording 206 from the point of view of the participatory user. In this way, the non-participatory user would experience substantially the same events as the participatory user did.

But, since the experiential recording is really a virtual world that is playing back world state events, it is possible for the non-participatory user to generate some of their own world state events, which promotes the non-participatory user into a quasi-participatory user. Whereas a non-participatory user is a user who consumes world state events that were generated in another instance of the world without generating new state events, a quasi-participatory user both consumes the world state events from another instance of the world and generates new world state events in the instance of the world in which they are viewing the experiential recording.

In a quasi-experiential recording, the avatars that are part of the experiential recording are not controlled by users. Those avatars exist or existed in another instance of the world. In some ways, they are like non-player characters. These avatars can only move or speak in the way they moved or spoke in the experiential recording. But the client that is associated with the quasi-participatory user 302 is present in the instance of the virtual world in which the experiential recording is being played back, so they could provide inputs into that virtual world. Those inputs would not impact the virtual world instance from the experiential recording, but those inputs can be used to control that player's point of view, as a not rendered player (ghost) or a rendered player (avatar). The presence of the player associated with the client that is associated with the quasi-participatory user 302 differentiates a quasi-experiential recording from an experiential recording.

In some embodiment, such as illustrated in FIG. 3, a non-participatory user can become a quasi-participatory user. In FIG. 3, client 302 is playing back a view of experiential recording 206. Once the user associated with client 302 attempts to take control of the avatar through which they are viewing the world, a new player is spawned that the now quasi-participatory user can control. In perspective view 304, the quasi-experiential recording is being viewed from the newly spawned player, which can now see the avatar through which they were previously viewing the world. A new player needs to be spawned as an avatar or ghost because the avatars from the experiential recording are controlled by the state in the experiential recording or quasi-experiential recording and cannot be controlled by the user. In contrast, the player (as an avatar or ghost) can be moved around the virtual world to explore additional points of view.

In some embodiments, the new player can be rendered in the world or not rendered in the world. In both instances, the user experiencing the quasi-experiential recording can navigate the world and see how it was when the quasi-experiential recording was recorded. If the user does not choose to have an avatar rendered, the experience is like being a ghost that explores a world. But if the user chooses to be rendered as an avatar, the user can interact and speak with other users that are also viewing the same quasi-experiential recording at the same time.

More examples of when and how an experiential recording or a quasi-experiential recording might be used will be addressed herein.

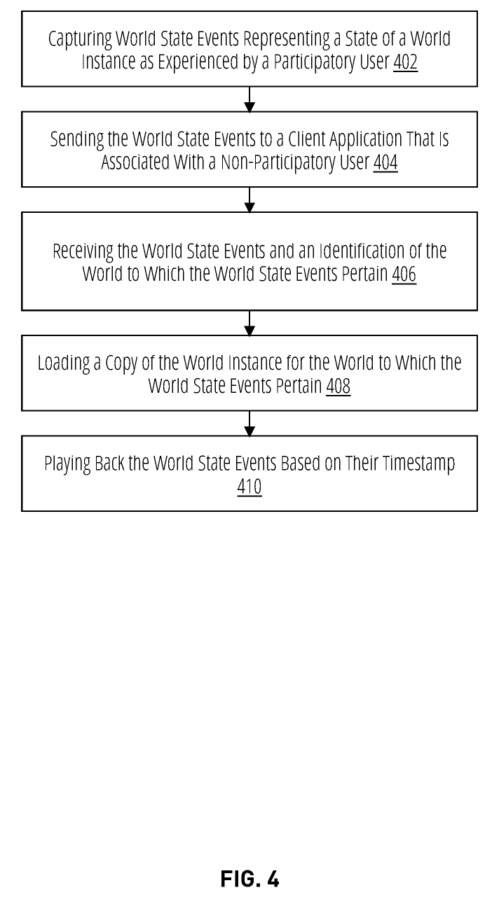

FIG. 4 illustrates an example method for capturing an experiential recording and playing back the experiential recording in accordance with some embodiments of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

As addressed herein, the present technology pertains to capturing the experiences of a participatory user for viewing by a non-participatory user or quasi-participatory user. The non-participatory user can be the same user as the participatory user or quasi-participatory user, but at a different time (a user captures an experience to consume later). The non-participatory user could be a different user consuming the experiences of the participatory user substantially as they happen (e.g., a live stream).

Here are some example use cases to which the present technology can apply: a participatory user captures an experiential recording for their later viewing as a non-participatory user. a participatory user captures an experiential recording for their later viewing a quasi-participatory user. For example, the user wants to be able to view the events happening in a virtual world from different points of view at a later time. a participatory user captures an experiential recording for later viewing by others as a non-participatory user or quasi-participatory user. a participatory user livestreams their experiences for current viewing by others. a participatory user desires to create a quasi-experiential recording so that other users can experience events in a virtual world at a later time. For example, a performer could perform in a virtual world and can create a quasi-experiential recording so that quasi-participatory users can gather to experience the quasi-experiential recording from their desired perspective.

The method illustrated in FIG. 4 is a high level method that can support all of these example use cases. Methods addressed with respect to other figures will address more specific use cases or embodiments of the present technology in greater detail.

According to some examples, the method includes capturing world state events representing a state of a world instance as experienced by a participatory user, at block 402. For example, the networking services 112 or client 104 illustrated in FIG. 1 may capture world state events representing a state of a world instance as experienced by a participatory user. Perhaps, this is more accurately phrased that the world state events captured by the client or networking services as these events were received.

In some embodiments, networking services 112 can capture the world state events since it is the function of networking services 112 to distribute world state events to clients that have a session with the same world instance. When networking services 112 captures the world state events for the purpose of creating an experiential recording, networking services 112 would need to label data for the user creating the experiential recording to be differentiated from the rest so that the client that is associated with the non-participatory user knows which avatar to render as if it were the local player 116. This is not needed in the quasi-participatory user embodiments, since the local player is controlled by the user of the client that is associated with the quasi-participatory user.

In some embodiments, client 104 can capture the world state events since it is receiving or creating all of the world state events that are part of the experiential recording. The client 104 already differentiates data for the local player 116 compared to the remote players 124 so that differentiation could be maintained in the experiential recording so that when the experiential recording was played, the client that is associated with the non-participatory user would playback the events from the point of view of the local player 116 in the experiential recording.

The world state events include any events that are needed to render a copy of the world in the same state as it existed when the experiential recording was captured. The world state events include the identification of avatars that are present in the world instance, initial locations of the avatars, kinematics data for the avatars, and audio data for the avatars. In some embodiments, the world state events can also include an identification of non-world-native objects (other objects brought into the world) as these objects are part of the copy of the world. The world state events are captured over time and associated with timestamps corresponding to relative times in which the world state events are captured.

In some embodiments, the capturing of the world state events refers to copying and storing the world state events into a file. When a file is created, it can be initially stored at the client or web services 110. In some embodiments, the capturing of the world state events includes streaming the world state events from the world instance to a client that is associated with the non-participatory user.

According to some examples, the method includes sending the world state events to a client that is associated with the non-participatory user at block 404. For example, the networking services 112 or web services 110 illustrated in FIG. 1 may send the world state events to the client that is associated with the non-participatory user. The client that is associated with the non-participatory user is configured to replay the world state events so that the non-participatory user can experience the experiential recording as it was captured by the participatory user using the client or networking services.

The sending of the world state event can include transmitting a file by web services 110 including all of the events that are part of the experiential recording, or can include streaming the world state events by the networking services 112 to the client that is associated with the non-participatory user. The events can be streamed in both the example of a live stream or in the example of a previously recorded experiential recording that might be stored using experiential recording service 148.

According to some examples, the method includes receiving the world state events and an identification of the world to which the world state events pertain at block 406. For example, the client that is associated with the non-participatory user (or quasi-participatory user) 302 illustrated in FIG. 3 may receive the world state events and an identification of the world to which the world state events pertain.

According to some examples, the method includes loading a copy of the world instance for the world to which the world state events pertain at block 408. For example, the client that is associated with the non-participatory user (or quasi-participatory user) 302 illustrated in FIG. 3 may load a copy of the world instance for the world to which the world state events pertain.

In some embodiments, a world is a file or collection of files that make up a virtual world. But there is a limit to the number of users that can be active in a world at one time and still allow respective client devices to maintain good performance while rendering the world. Accordingly, there can be any number of identical world instances at any time. Each world instance is a copy of the files that make up the world to which particular users (and their avatars) are assigned. Thus two different users interacting with two different world instances for the same world will not be able to interact with each other because their avatars are in different copies of the world.

In the case of experiential recordings, the participatory user and the non-participatory user are generally not in the same world instance at the same time. Generally, the client 302 receives an identification of the world, and can request a world instance for that world from worlds API 128. Often the non-participatory user will be the only live user in the world instance. Generally, other avatars in the world instance will be part of the experiential recording. But in some embodiments, a group of non-participatory users might all want to experience the experiential recording at the same time and thus it is possible for them to all be in the same world instance. Additionally, in some embodiments of quasi-experiential recordings, it might be explicitly intended that a group of quasi-participatory users will be in the same world instance. As will be addressed below, some avatars in the quasi-experiential recording will be part of the recording, and some will be live users that can interact.

According to some examples, the method includes playing back the world state events based on their timestamp at block 410. For example, the client that is associated with the non-participatory user (or quasi-participatory user) 302 illustrated in FIG. 3 may playback the world state events based on their timestamp. The playback of the world state events includes directing a field of view of the non-participatory user in accordance with state events for the participatory user when the non-participatory user passively views the world from the same point of view as the participatory user. In some embodiments, the user can choose which recorded avatars from which to view the experiential recording. It is not necessary to only view the world from the point of the view of the user that made the experiential recording. Also, a user can decide to explore the experiential recording from new points of view that have not been occupied by avatars in the experiential recording by exploring the experiential recording as a quasi-participatory user.

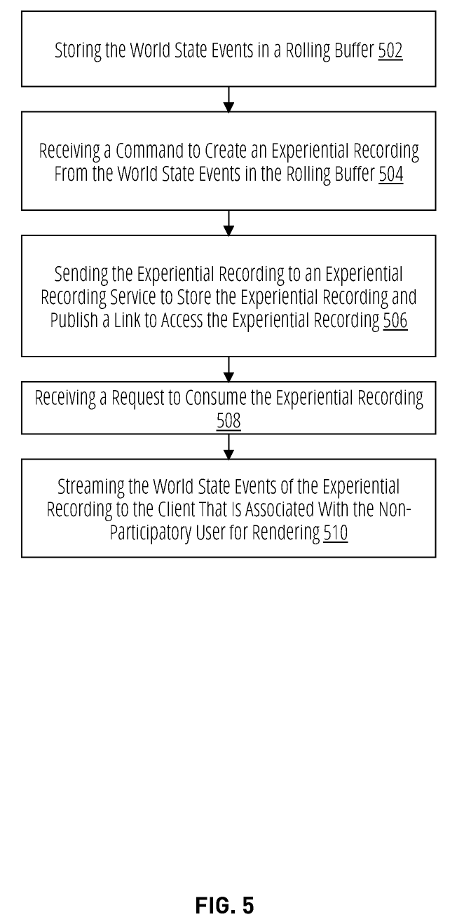

FIG. 5 illustrates an example method for capturing world state events to be part of an experiential recording and providing access to the experiential recording in accordance with some embodiments of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

FIG. 5 addresses the mechanism by which world state events are captured at the right time. While a user is likely interacting in a virtual world with the expectation of enjoying themselves, it is hard to predict that an experience worth sharing will come up in the future. While, some experiences can be planned, often a user won't know they want to share an experience until after the experience is over. Therefore, the present technology can use any of several methods to help make sure experiential recordings can be saved after an experience has occurred.

According to some examples, the method includes storing the world state events in a rolling buffer at block 502. For example, the client that is associated with the participatory user 202 illustrated in FIG. 2 may store the world state events in a rolling buffer. The rolling buffer can record all world state events that have occurred in a previous period (e.g., 30-secs, 1-min, 5-min, or even for a whole session in a world instance, etc.). In a mechanism like this, the world state events can be stored for a short period of time such that the user does not need to initiate recording of world state events before an experience occurs. Using the rolling buffer, the world state events are always recorded, and after the experience has occurred, the user could then decide to save the experiential recording as addressed with respect to block 504. The rolling buffer is a data storage mechanism that continuously records and stores recent world state events within a predetermined duration, such as 30 seconds to a few minutes. The buffer operates by overwriting old data with new data once its capacity is reached, ensuring that only the most recent events are retained. This allows users to capture and save events from just before they decide to create a permanent recording, thereby eliminating the need to start recording in advance. The rolling buffer ensures that users can retrospectively capture an experience after it occurs.

Two possible locations for storing world state events in the rolling buffer can be the client that is associated with the participatory user 202 or the networking services 112 streaming events to the experiential recording service 148 for storage.

In some embodiments, rather than maintaining the rolling buffer at all times, the rolling buffer can be initiated in response to a determination made by a heuristic or trained machine learning model to start the rolling buffer automatically based on an analysis of content or interactions occurring in the world. The heuristic or trained machine learning model could predict that a moment worth sharing as an experiential recording is about to occur and initiate the rolling buffer.

According to some examples, the method includes receiving a command to create an experiential recording from the world state events in the rolling buffer at block 504. For example, the client that is associated with the participatory user 202 illustrated in FIG. 2 may receive a command to create an experiential recording from the world state events in the rolling buffer. The rolling buffer can store the world state events needed to reproduce an experience of the participatory user as an experiential recording.

According to some examples, the method includes sending the experiential recording to an experiential recording service to store the experiential recording and publish a link to access the experiential recording at block 506. For example, the client that is associated with the participatory user 202 illustrated in FIG. 2 may send the experiential recording to an experiential recording service to store the experiential recording and publish a link to access the experiential recording. In some embodiments, the link to the experiential recording could point to the experiential recording saved on client that is associated with the participatory user 202, but more likely the experiential recording will be stored via web services 110 or in a file sharing service accessible via the link.

According to some examples, the method includes receiving a request to consume the experiential recording at block 508. For example, the experiential recording service 148 illustrated in FIG. 1 may receive a request to consume the experiential recording from a client that is associated with the non-participatory user. The request comes as a result of the non-participatory user following the link. The link was shared, directly or indirectly, with the non-participatory user by the participatory user. In some embodiments, the link can be associated with a password or be protected by an access control list that would prevent unauthorized users from viewing the experiential recording.

Note, while the present description refers to a non-participatory user viewing the experiential recording, the non-participatory user can be the same user as the participatory user, except that the user is a participatory user when participating in the event memorialized in the experiential recording, and the user is a non-participatory user when consuming the experience as a memory at a later time.

According to some examples, the method includes streaming the world state events of the experiential recording to the client that is associated with the non-participatory user for rendering at block 510. For example, the experiential recording service 148 illustrated in FIG. 1 may stream the world state events of the experiential recording to the client that is associated with the non-participatory user for rendering. The whole file could be sent all at once, too, as addressed with respect to block 404, above.

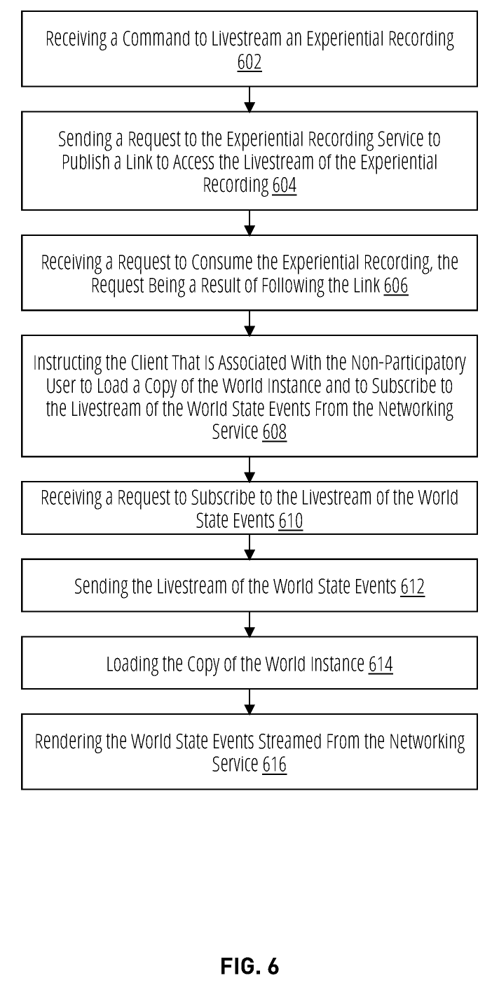

FIG. 6 illustrates an example method for livestreaming an experiential recording in accordance with some embodiments of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

While FIG. 5 addressed how to capture an experience that has already occurred as an experiential recording, FIG. 6 addresses that some users will want to share their experiences in near-real-time. While a user could coordinate that a few other users all join them in a world instance at the same time to experience a world instance together, there is a limit to the number of users that can be in a world instance together. Therefore, especially for users who might have a large social following, the present technology can be used to allow non-participatory users to watch the participatory user in live action. The non-participatory users watching the live stream will be in another instance of the world than the instance that the participatory user is in, but they will be able to experience events from the point of view of the participatory user.

According to some examples, the method includes receiving a command to livestream an experiential recording at block 602. For example, the client that is associated with the participatory user 202 illustrated in FIG. 2 may receive a command to livestream an experiential recording. The experiential recording for the livestream includes streaming the world state events needed to reproduce an experience of the participatory user as the world state events occur.

According to some examples, the method includes sending a request to the experiential recording service to publish a link to access the livestream of the experiential recording at block 604. For example, the client that is associated with the participatory user 202 illustrated in FIG. 2 may send a request to the experiential recording service to publish a link to access the livestream of the experiential recording. The link can be shared with friends and followers of the participatory user.

According to some examples, the method includes receiving a request to consume the experiential recording at block 606. For example, the experiential recording service 148 illustrated in FIG. 1 may receive a request from one or more non-participatory users to consume the experiential recording. The request is the result of the non-participatory user following the link.

According to some examples, the method includes instructing the client that is associated with the non-participatory user to load a copy of the world instance and to subscribe to the livestream of the world state events from the networking service at block 608. For example, the experiential recording service 148 illustrated in FIG. 1 may instruct the client that is associated with the non-participatory user to load a copy of the world instance and to subscribe to the live stream of the world state events from the networking service.

According to some examples, the method includes receiving a request to subscribe to the livestream of the world state events at block 610. For example, the networking services 112 illustrated in FIG. 1 may receive a request to subscribe to the livestream of the world state events.

According to some examples, the method includes sending the livestream of the world state events at block 612. For example, the networking services 112 illustrated in FIG. 1 may send the livestream of the world state events. The client application could also do the streaming, but it makes more sense for the networking services to send out the events as they already are doing.

According to some examples, the method includes loading the copy of the world instance at block 614. For example, the client that is associated with the non-participatory user (or quasi-participatory user) 302 illustrated in FIG. 3 may load the copy of the world instance.

According to some examples, the method includes rendering the world state events streamed from the networking service at block 616. For example, the client that is associated with the non-participatory user (or quasi-participatory user) 302 illustrated in FIG. 3 may render the world state events streamed from the networking service into the copy of the world instance.

The copy of the world instance is not eligible to publish events occurring in the copy of the world instance to the world containing the participatory user, so the non-participatory users cannot affect the state of the world instance containing the participatory user. However, in some embodiments, the copy of the world instance can publish events occurring in the copy of the world instance to other renderings of the same copy of the world instance. Therefore, if there were multiple non-participatory users in the copy of the world instance, they would all be perceiving the events of the livestream of the experiential recording in the copy of the world instance. The non-participatory users could become quasi-participatory users if they decided to start to generate their own state events through speaking or interacting with the copy of the world instance through their avatar. This could create a social environment for watching the livestream where users in the copy of the world instance could discuss or interact around the livestream.

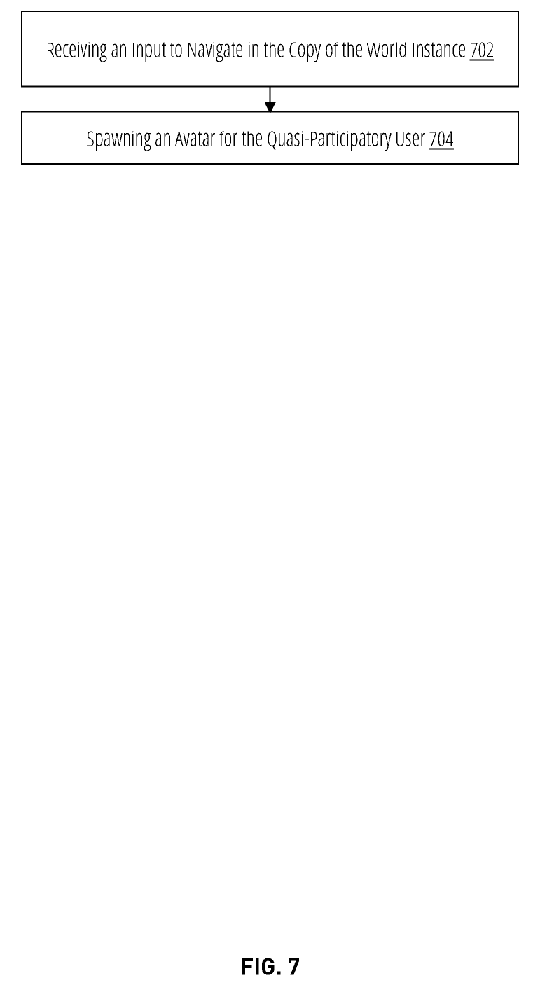

FIG. 7 illustrates an example method for elevating a non-participatory user to a quasi-participatory user in accordance with some embodiments of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

As addressed herein, a user is a non-participatory user when they passively consume world state events in an experiential recording. Thereby, the client that is associated with the non-participatory user will control the point of view of the non-participatory user to experience the virtual world in the same way as the participatory user did. But, since the copy of the virtual world is a live world instance, the non-participatory user could decide to explore the world separate from the specific point of view of the participatory user, by generating their own world state events through talking or providing inputs to navigate an avatar.

According to some examples, the method includes receiving an input to navigate or speak in the copy of the world instance at block 702. For example, the client that is associated with the non-participatory user (or quasi-participatory user) 302 illustrated in FIG. 3 may receive an input to navigate or speak or otherwise create world state events in the copy of the world instance.

According to some examples, the method includes spawning an avatar for the quasi-participatory user at block 704. For example, the client that is associated with the non-participatory user (or quasi-participatory user) 302 illustrated in FIG. 3 may spawn an avatar for the quasi-participatory user.

Initially, the non-participatory user perceives the world through the eyes of the participatory user that made the experiential recording. But, when the non-participatory user starts generating world state events, they promote themselves to a quasi-participatory user, and their client 302 can spawn an avatar, as addressed with respect to FIG. 3. The generated world state events are attributed to the new avatar for the quasi-participatory user.

A quasi-participatory user is one that can navigate the copy of the world instance, but whose actions are not reflected to the world instance including the participatory user. The copy of the world instance is not eligible to publish events occurring in the copy of the world instance to the world containing the participatory user. The copy of the world instance can publish events occurring in the copy of the world instance to other renderings of the same copy of the world instance.

Navigation inputs are effective to navigate the avatar for the quasi-participatory user about the copy of the world instance. Speech inputs can be effective to speak to other non-participatory user or quasi-participatory users in the copy of the virtual world.

Generally, any inputs provided into the world instance are world state events rendered and played in the copy of the world so that all users in a world instance receive those world state events. One exception to this general operation is if a user has content filters enabled. Any user can block world state events generated by certain avatars (e.g., one setting could block all quasi-participatory users from being rendered) from being rendered. In this instance, the user blocking state events from a user or class of users can cause their client to filter these state events or to instruct the networking service to not even forward those world state events.

In embodiments wherein new world state events are generated on top of an experiential recording, these can be recorded as a new experiential recording. The new world state events cause a branch in the experiential recording.

In some embodiments, when a user is consuming the experiential recording as a quasi-participatory user, the avatars that are rendered from the recorded state events can be labeled so that the quasi-participatory user understands that these avatars are not able to react because they are not controlled by live users or even an artificial intelligence (such as a user might expect from a non-player character).

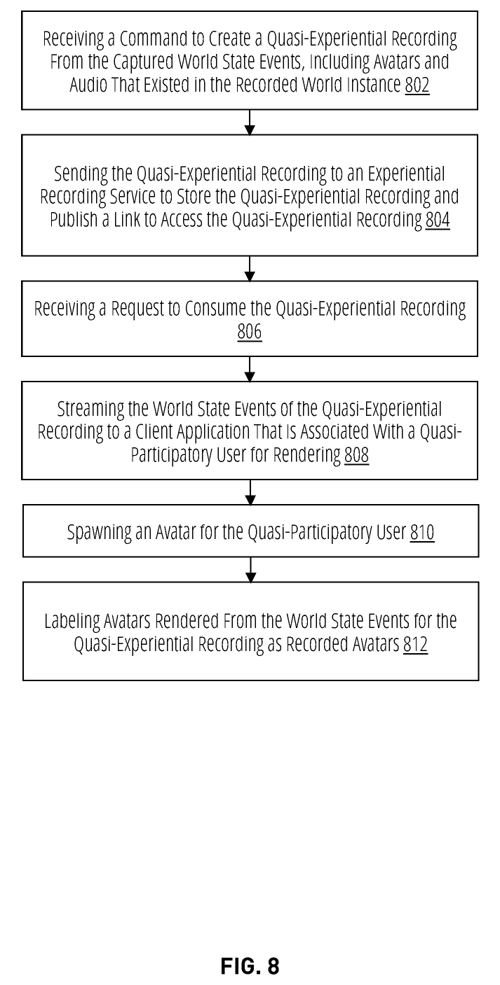

FIG. 8 illustrates an example method for explicitly creating a quasi-experiential recording in accordance with some embodiments of the present technology. Although the example method depicts a particular sequence of operations, the sequence may be altered without departing from the scope of the present disclosure. For example, some of the operations depicted may be performed in parallel or in a different sequence that does not materially affect the function of the method. In other examples, different components of an example device or system that implements the method may perform functions at substantially the same time or in a specific sequence.

In some embodiments, a participatory user might desire to create a quasi-experiential recording wherein the participatory user wants the quasi-participatory user to be initially rendered with their own avatar. One possible example where this might be relevant is when a performer is the participatory user. In this example, the performer might want to create an experience in a virtual world built around their performance where users/fans can attend the performance. In this example, the quasi-participatory user cannot experience the experiential recording as another avatar such as the performer.

The main technical difference between a quasi-experiential recording and an experiential recording is that quasi-experiential recording requires the user to experience the experiential recording as a quasi-participatory user having their own avatar.

According to some examples, the method includes receiving a command to create a quasi-experiential recording from the captured world state events, including avatars and audio that existed in the recorded world instance at block 802. For example, the client that is associated with the participatory user 202 illustrated in FIG. 2 may receive a command to create a quasi-experiential recording from the captured world state events, including avatars and audio that existed in the recorded world instance. The quasi-experiential recording includes the world state events needed to reproduce the recorded world instance.

According to some examples, the method includes sending the quasi-experiential recording to an experiential recording service to store the quasi-experiential recording and publish a link to access the quasi-experiential recording at block 804. For example, the client that is associated with the participatory user 202 illustrated in FIG. 2 may send the quasi-experiential recording to an experiential recording service to store the quasi-experiential recording and publish a link to access the quasi-experiential recording.

According to some examples, the method includes receiving a request to consume the quasi-experiential recording at block 806. For example, the experiential recording service 148 illustrated in FIG. 1 may receive a request to consume the quasi-experiential recording. The request is received as a result of the quasi-participatory user following the link.

According to some examples, the method includes streaming the world state events of the quasi-experiential recording to a client application that is associated with a quasi-participatory user for rendering at block 808. For example, the experiential recording service 148 illustrated in FIG. 1 may stream the world state events of the quasi-experiential recording to a client application that is associated with a quasi-participatory user for rendering. A quasi-participatory user is one that can navigate the copy of the world instance, but whose actions are not reflected to the world instance including the participatory user. The copy of the world instance is not eligible to publish events occurring in the copy of the world instance to the world containing the participatory user. The copy of the world instance can publish events occurring in the copy of the world instance to other renderings of the same copy of the world instance.

According to some examples, the method includes spawning an avatar for the quasi-participatory user at block 810. For example, the client that is associated with the non-participatory user (or quasi-participatory user) 302 illustrated in FIG. 3 may spawn an avatar for the quasi-participatory user. Navigation inputs are effective to navigate the avatar for the quasi-participatory user about the copy of the world instance.

According to some examples, the method includes labeling avatars rendered from the world state events for the quasi-experiential recording as recorded avatars at block 812. For example, the client that is associated with the non-participatory user (or quasi-participatory user) 302 illustrated in FIG. 3 may label avatars rendered from the world state events for the quasi-experiential recording as recorded avatars (e.g., avatars that are not interactable are marked as recorded).

In some embodiments, in both an experiential recording or quasi-experiential recording, the experience can be labeled with content flags or age ratings such that a non-participatory user or quasi-participatory user might be prohibited from viewing a recording that is not age appropriate or that has content for which their user settings desire to filter. In some embodiments, a user accounts settings can also be used to filter selected world state events such that the user can still consume the experiential recording, but might not have all world state events rendered by their client.

In some embodiments, the present technology enables a multi-user experiential recording in which multiple quasi-participatory users may concurrently join a recorded experience. In such embodiments, the system captures world state events—comprising avatar positions, kinematics data, and audio cues—from the original participatory user and streams these events to multiple clients simultaneously. The clients associated with quasi-participatory users, can interact with the recorded environment in a manner that is transmitted to the clients of other quasi-participatory users of the experiential recording. This arrangement allows multiple quasi-participatory users to experience and interact with the reproduced virtual world together, but from their respective perspectives.

In some embodiments, the present technology supports the capturing of a specific state of a virtual world from which further interaction may proceed. Here, the system records a defined snapshot of the world—capturing the precise arrangement of avatars, objects, and environmental conditions at a critical moment—and preserves the associated state events with their respective timestamps. Subsequent users may join the experiential recording at this captured state as quasi-participatory users who inject new state events while navigating the replay. This feature ensures that the integrity of the original recorded moment is maintained, while still allowing interactive exploration and engagement from that fixed point onward.

In some embodiments, the present technology provides robust remixing and editing capabilities for experiential recordings. Leveraging the modular nature of captured world state events, a user can access and modify the recording much like editing a video. Users may splice together different segments, alter or combine specific state events, and adjust the timing or sequencing of interactions to generate a composite or remixed experience. This editing functionality enables modifications at the granular level—such as selectively reassigning avatar interactions or modifying object states—while preserving the immersive and interactive characteristics of the original recording. The resulting experiential recordings or quasi-experiential recordings retain the foundational structure of the captured world instance but offer a tailored narrative or interactive experience based on user modifications.

These embodiments further illustrate the versatility of the present technology in accommodating a range of use cases—from collaborative multi-user interactions to fixed-state re-entries and creative post-capture modifications.

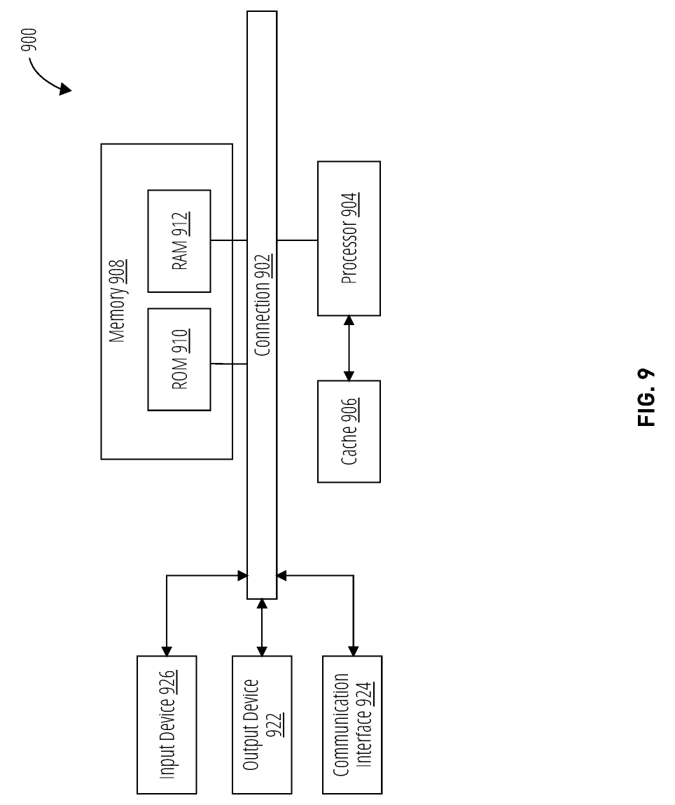

FIG. 9 shows an example of computing system 900, which can be, for example, any computing device making up any component illustrated in FIG. 1.

In some embodiments, computing system 900 is a single device, or a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

In some embodiments, computing system 900 may comprise one or more computing resources provisioned from a “cloud computing” provider, For example, AMAZON ELASTIC COMPUTE CLOUD (“AMAZON EC2”), provided by AMAZON, INC. of Seattle, Washington; SUN CLOUD COMPUTER UTILITY, provided by SUN MICROSYSTEMS, INC. of Santa Clara, California; AZURE, provided by MICROSOFT CORPORATION of Redmond, Washington, GOOGLE CLOUD PLATFORM, provided by ALPHABET, INC. of Mountain View, California, and the like.

Example computing system 900 includes at least one processing unit (CPU or processor) 904 and connection 902 that couples various system components including system memory 908, such as read-only memory (ROM) 910 and random access memory (RAM) 912 to processor 904. Memory 908 can be a volatile or non-volatile memory device, and can be a hard disk or other types of non-transitory computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

Memory 908 can include software services, servers, logic, etc., that when the code that defines such software is executed by the processor 904, it causes the system to perform a function. In some embodiments, a hardware service that performs a particular function can include the software component stored in a computer-readable medium in connection with the necessary hardware components, such as processor 904, connection 902, output device 922, etc., to carry out the function.

Computing system 900 can include a cache of high-speed memory 906 connected directly with, in close proximity to, or integrated as part of processor 904.

Connection 902 can be a physical connection via a bus, or a direct connection into processor 904, such as in a chipset architecture. Connection 902 can also be a virtual connection, networked connection, or logical connection.

Processor 904 can include any general purpose processor and a hardware service or software service stored in memory 908, configured to control processor 904 as well as a special-purpose processor where software instructions are incorporated into the actual processor design. Processor 904 may essentially be a completely self-contained computing system, containing multiple cores or processors, a bus, memory controller, cache, etc. A multi-core processor may be symmetric or asymmetric. Processor 904 can be physcial or virtual.

To enable user interaction, computing system 900 includes an input device 926, which can represent any number of input mechanisms, such as a microphone for speech, a touch-sensitive screen for gesture or graphical input, keyboard, mouse, motion input, speech, etc. Computing system 900 can also include output device 922, which can be one or more of a number of output mechanisms known to those of skill in the art. In some instances, multimodal systems can enable a user to provide multiple types of input/output to communicate with computing system 900. Computing system 900 can include communication interface 924, which can generally govern and manage the user input and system output. There is no restriction on operating on any particular hardware arrangement, and therefore the basic features here may easily be substituted for improved hardware or firmware arrangements as they are developed.

In some embodiments, computing system 900 can refer to a combination of a personal computing device interacting with components hosted in a data center, where both the computing device and the components in the data center. In such examples, both the personal computing device and the components in the datacenter might have a processor, cache, memory, storage, etc.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain embodiments within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

### Aspects

The present technology includes computer-readable storage mediums for storing instructions, and systems for executing any one of the methods embodied in the instructions addressed in the aspects of the present technology presented below:

Aspect 1: A method comprising: capturing, by a networking service, world state events representing a state of a world instance as experienced by a participatory user, the world state events include identification of avatars that are present in the world instance, initial locations of the avatars, kinematics data for the avatars, and audio data, wherein the world state events are captured over time and associated with timestamps corresponding to relative times in which the world state events are captured, wherein the capturing includes streaming the world state events from the world instance and includes recording the world state events over a period and storing the world state events; sending, by the networking service, the world state events to a client that is associated with a non-participatory user, wherein the client that is associated with the non-participatory user is configured to replay the world state events so that the non-participatory user can experience the world instance as experienced by the participatory user.

Aspect 2: The method of aspect 1, further comprising: receiving, by the client that is associated with the non-participatory user, the world state events and an identification of a world to which the world state events pertain; loading a copy of the world instance for the world to which the world state events pertain; and playing back the world state events based on their timestamp.

Aspect 3: The method of any one of aspects 1-2, wherein the world state events also include an identification of non-world-native objects (other objects brought into the world).

Aspect 4: The method of any one of aspects 1-3, further comprising: storing, by a client that is associated with the participatory user, the world state events in a rolling buffer; receiving, by the client that is associated with the participatory user, a command to create an experiential recording from the world state events in the rolling buffer, wherein the experiential recording includes the world state events needed to reproduce an experience of the participatory user, wherein the rolling buffer stores world state events for a past period; sending, by the client that is associated with the participatory user, the experiential recording to an experiential recording service to store the experiential recording and publish a link to access the experiential recording; receiving, by the experiential recording service, a request to consume the experiential recording, the request being a result of following the link; streaming, by the experiential recording service, the world state events of the experiential recording to the client that is associated with the non-participatory user for rendering.

Aspect 5: The method of any one of aspects 1-4, wherein the rolling buffer is initiated in response to a determination made by a heuristic or trained machine learning model to start rolling buffer automatically based on an analysis of content or interactions occurring in the world.

Aspect 6: The method of any one of aspects 1-5, further comprising: receiving, by a client that is associated with the participatory user, a command to livestream an experiential recording, wherein the experiential recording for the livestream includes streaming the world state events needed to reproduce an experience of the participatory user as the world state events occur; sending, by the client that is associated with the participatory user, a request to a experiential recording service to publish a link to access the livestream of the experiential recording; receiving, by the experiential recording service, a request to consume the experiential recording, the request being a result of following the link; instructing, by the experiential recording service, the client that is associated with the non-participatory user to load a copy of the world instance and to subscribe to the livestream of the world state events from the networking service, wherein the copy of the world instance is not eligible to publish events occurring in the copy of the world instance to the world containing the participatory user, wherein the copy of the world instance can publish events occurring in the copy of the world instance to other renderings of the same copy of the world instance; receiving, by the networking service, a request to subscribe to the livestream of the world state events; sending, by the networking service, the livestream of the world state events; loading, by the client that is associated with the non-participatory user, the copy of the world instance; and rendering, by the client that is associated with the non-participatory user, the world state events streamed from the networking service.

Aspect 7: The method of any one of aspects 1-6, wherein the playing back the world state events includes directing a field of view of the non-participatory user in accordance with state events for the participatory user, whereby the non-participatory user passively views the world from the same point of view as the participatory user.

Aspect 8: The method of any one of aspects 1-7, further comprising: receiving, by the client that is associated with the non-participatory user, an input to navigate in the copy of the world instance, wherein the non-participatory user becomes a quasi-participatory user, wherein a quasi-participatory user is one that can navigate the copy of the world instance, but whose actions are not reflected to the world instance including the participatory user, wherein the copy of the world instance is not eligible to publish events occurring in the copy of the world instance to the world containing the participatory user, wherein the copy of the world instance can publish events occurring in the copy of the world instance to other renderings of the same copy of the world instance; spawning, by client that is associated with the non-participatory user, an avatar for the quasi-participatory user, wherein navigation inputs are effective to navigate the avatar for the quasi-participatory user about the copy of the world instance.

Aspect 9: The method of any one of aspects 1-8, wherein new network events generated in the copy of the world instance can be recorded as a new experiential recording, where the new network events cause a branch in the experiential recording.

Aspect 10: The method of any one of aspects 1-9, further comprising: receiving, by the client that is associated with the participatory user, a command to create a quasi-experiential recording from the captured world state events, wherein the quasi-experiential recording includes the world state events needed to reproduce a recorded world instance, including avatars and audio that existed in the recorded world instance; sending, by the client that is associated with the participatory user, the quasi-experiential recording to an experiential recording service to store the quasi-experiential recording and publish a link to access the quasi-experiential recording; receiving, by the experiential recording service, a request to consume the quasi-experiential recording, the request being a result of following the link; streaming, by the experiential recording service, the world state events of the quasi-experiential recording to a client application that is associated with a quasi-participatory user for rendering, wherein a quasi-participatory user is one that can navigate the copy of the world instance, but whose actions are not reflected to the world instance including the participatory user, wherein the copy of the world instance is not eligible to publish events occurring in the copy of the world instance to the world containing the participatory user, wherein the copy of the world instance can publish events occurring in the copy of the world instance to other renderings of the same copy of the world instance; spawning, by client that is associated with the non-participatory user, an avatar for the quasi-participatory user, wherein navigation inputs are effective to navigate the avatar for the quasi-participatory user about the copy of the world instance.

Aspect 11: The method of any one of aspects 1-10, further comprising: labeling, by the client that is associated with the non-participatory user, avatars rendered from the world state events for the quasi-experiential recording as recorded avatars, whereby avatars that are not interactable are marked as recorded.

What is claimed is:

1. A method comprising:
capturing world state events representing a state of a world instance as experienced by a participatory user, the world state events include identification of avatars that are present in the world instance, initial locations of the avatars, kinematics data for the avatars, and audio data, wherein the world state events are captured over time and associated with timestamps corresponding to relative times in which the world state events are captured;
sending the world state events to a client that is associated with a non-participatory user, wherein the client that is associated with the non-participatory user is configured to replay the world state events so that the non-participatory user can experience the world instance as caused to be captured by the participatory user.

2. The method of claim 1, further comprising:
receiving the world state events and an identification of a world to which the world state events pertain;
loading a copy of the world instance for the world to which the world state events pertain; and
playing back the world state events based on their timestamp.

3. The method of claim 1, further comprising:
storing the world state events in a rolling buffer;
receiving a command to create an experiential recording from the world state events in the rolling buffer;
sending the experiential recording to an experiential recording service to store the experiential recording and publish a link to access the experiential recording;
receiving a request to consume the experiential recording, the request being a result of following the link;
streaming the world state events of the experiential recording to the client that is associated with the non-participatory user for rendering.

4. The method of claim 3, wherein the experiential recording includes the world state events needed to reproduce an experience of the participatory user, wherein the rolling buffer stores world state events for a past period.

5. The method of claim 1, further comprising:
receiving, by a client that is associated with the participatory user, a command to livestream an experiential recording, wherein the experiential recording includes the world state events;
receiving, by the networking service, a request to subscribe to the livestream of the world state events;
sending, by the networking service, the livestream of the world state events;
loading, by the client that is associated with the non-participatory user, the copy of the world instance; and
rendering, by the client that is associated with the non-participatory user, the world state events streamed from the networking service.

6. The method of claim 5, wherein the copy of the world instance is not eligible to publish events occurring in the copy of the world instance to the world containing the participatory user, wherein the copy of the world instance can publish events occurring in the copy of the world instance to other renderings of the same copy of the world instance.

7. The method of claim 2, wherein the playing back the world state events includes directing a field of view of the non-participatory user in accordance with state events for the participatory user, whereby the non-participatory user passively views the world from the same point of view as the participatory user.

8. The method of claim 7, further comprising:
receiving an input to navigate in the copy of the world instance, wherein the non-participatory user becomes a quasi-participatory user;
spawning the quasi-participatory user, wherein navigation inputs are effective to navigate the quasi-participatory user about the copy of the world instance.

9. The method of claim 8, wherein the quasi-participatory user is represented by an avatar in the copy of the world instance.

10. The method of claim 8, wherein the quasi-participatory user is not rendered in the copy of the world instance, whereby the quasi-participatory user experiences the experiential recording as a ghost.

11. The method of claim 1, further comprising:
receiving a command to create a quasi-experiential recording from the captured world state events, wherein a quasi-experiential recording requires consumption by a quasi-participatory user;
sending the quasi-experiential recording to an experiential recording service to store the quasi-experiential recording and publish a link to access the quasi-experiential recording;
receiving a request to consume the quasi-experiential recording, the request being a result of following the link;
streaming the world state events of the quasi-experiential recording to a client application that is associated with the quasi-participatory user for rendering;
spawning the quasi-participatory user, wherein navigation inputs are effective to navigate the quasi-participatory user about the copy of the world instance.

12. The method of claim 9, further comprising:
labeling avatars rendered from the world state events for the quasi-experiential recording as recorded avatars, whereby avatars that are not interactable are marked as recorded.

13. A system comprising:
at least one processor; and
a memory storing instructions that, when executed by the at least one processor, configure the system to:
capture world state events representing a state of a world instance as experienced by a participatory user, the world state events include identification of avatars that are present in the world instance, initial locations of the avatars, kinematics data for the avatars, and audio data, wherein the world state events are captured over time and associated with timestamps corresponding to relative times in which the world state events are captured;
send the world state events to a client that is associated with a non-participatory user, wherein the client that is associated with the non-participatory user is configured to replay the world state events so that the non-participatory user can experience the world instance as experienced by the participatory user.

14. The system of claim 13, wherein the instructions further configure the system to:
receive the world state events and an identification of a world to which the world state events pertain;
load a copy of the world instance for the world to which the world state events pertain; and
play back the world state events based on their timestamp.

15. The system of claim 13, wherein the instructions further configure the system to:
store the world state events in a rolling buffer;
receive a command to create an experiential recording from the world state events in the rolling buffer;
send the experiential recording to an experiential recording service to store the experiential recording and publish a link to access the experiential recording;
receive a request to consume the experiential recording, the request being a result of following the link;
stream the world state events of the experiential recording to the client that is associated with the non-participatory user for rendering.

16. The system of claim 14, wherein the playing back the world state events includes direct a field of view of the non-participatory user in accordance with state events for the participatory user, whereby the non-participatory user passively views the world from the same point of view as the participatory user.

17. The system of claim 16, wherein the instructions further configure the system to:
receive an input to navigate in the copy of the world instance, wherein the non-participatory user becomes a quasi-participatory user;
spawn an avatar for the quasi-participatory user, wherein navigation inputs are effective to navigate the avatar for the quasi-participatory user about the copy of the world instance.

18. A non-transitory computer-readable storage medium comprising instructions stored thereon that when executed by a at least one processor, cause the at least one processor to:
capture world state events representing a state of a world instance as experienced by a participatory user, the world state events include identification of avatars that are present in the world instance, initial locations of the avatars, kinematics data for the avatars, and audio data, wherein the world state events are captured over time and associated with timestamps corresponding to relative times in which the world state events are captured;
send the world state events to a client that is associated with a non-participatory user, wherein the client that is associated with the non-participatory user is configured to replay the world state events so that the non-participatory user can experience the world instance as experienced by the participatory user.

19. The non-transitory computer-readable storage medium of claim 18, wherein the instructions further configure the at least one processor to:
receive the world state events and an identification of a world to which the world state events pertain;
load a copy of the world instance for the world to which the world state events pertain; and
playback the world state events based on their timestamp.

20. The non-transitory computer-readable storage medium of claim 18, wherein the instructions further configure the at least one processor to:
store the world state events in a rolling buffer;
receive a command to create an experiential recording from the world state events in the rolling buffer;
send the experiential recording to an experiential recording service to store the experiential recording and publish a link to access the experiential recording;
receive a request to consume the experiential recording, the request being a result of following the link;
stream the world state events of the experiential recording to the client that is associated with the non-participatory user for rendering.

21. The non-transitory computer-readable storage medium of claim 18, wherein the instructions further configure the at least one processor to:
receive a command to livestream an experiential recording;
send a request to a experiential recording service to publish a link to access the livestream of the experiential recording;
receive a request to consume the experiential recording, the request being a result of following the link;
instruct the client that is associated with the non-participatory user to load a copy of the world instance and to subscribe to the livestream of the world state events from the networking service;
receive a request to subscribe to the livestream of the world state events;
send the livestream of the world state events;
load the copy of the world instance; and
render the world state events streamed from the networking service.

22. The non-transitory computer-readable storage medium of claim 18, wherein the instructions further configure the at least one processor to:
receive a command to create a quasi-experiential recording from the captured world state events;
send the quasi-experiential recording to an experiential recording service to store the quasi-experiential recording and publish a link to access the quasi-experiential recording;
receive a request to consume the quasi-experiential recording, the request being a result of following the link;
stream the world state events of the quasi-experiential recording to a client application that is associated with a quasi-participatory user for rendering;
spawn an avatar for the quasi-participatory user, wherein navigation inputs are effective to navigate the avatar for the quasi-participatory user about the copy of the world instance.
